(19) United States
(12) Patent Application Publication
(10) Pub. No.: US 2024/0162428 A1
(43) Pub. Date: May 16, 2024

(54) MICROCRYSTALLINE NANOSCALED SILICON PARTICLES AND USE THEREOF AS ACTIVE ANODE MATERIAL IN SECONDARY LITHIUM ION BATTERIES

(71) Applicant: CENATE AS, Askim (NO)

(72) Inventors: Martin Kirkengen, Askim (NO); Werner Filtvedt, Askim (NO); Erik Sauar, Oslo (NO)

(73) Assignee: CENATE AS, Askim (NO)

(21) Appl. No.: 18/552,551

(22) PCT Filed: Mar. 25, 2022
(86) PCT No.: PCT/EP2022/057998

§ 371 Date: Sep. 26, 2023

(30) Foreign Application Priority Data
Mar. 26, 2021 (GB) 2104362.5

(51) Int. Cl. H01M 4/38; C01B 33/029; H01M 4/02; H01M 4/133; H01M 4/134; H01M 4/36; H01M 4/587; H01M 4/62

(52) U.S. Cl. CPC H01M 4/386; C01B 33/029; H01M 4/133; H01M 4/134; H01M 4/366; H01M 4/587; H01M 4/622; H01M 4/625; C01P 2002/60; C01P 2002/72; C01P 2004/80; C01P 2006/12; C01P 2006/40; H01M 2004/021; H01M 2004/027

(57) ABSTRACT

The present invention concerns a method for manufacturing microcrystalline nanoscaled silicon particles, the particles made thereof, and a secondary electrochemical cell utilising the particles as the active material of the negative electrode of the secondary electrochemical cell, wherein the silicon particles comprises a chemical compound of formula: Si₍₁₋ₓ₎Mₓ, where 0.005≤x≤0.20 and M is at least one substitution element chosen from; C, N, or a mixture thereof, and wherein the particles have been subject to a heat treatment of 800 to 900° C. and transformed into a microcrystalline phase having crystallite sizes in the range of 1 to 15 nm.

The present invention concerns a method for manufacturing nanoscaled microcrystalline silicon particles, the particles made thereof, and a secondary electrochemical cell utilising the particles as the active material of the negative electrode of the secondary electrochemical cell.

### BACKGROUND

It will be necessary with a strong increase in the usage of renewable power and the electrification of many sectors in the society presently running on fossil fuel energy to meet the goals of The Paris Agreement under the UN Climate Convention. A vital part to obtain these goals is access to rechargeable batteries having excellent specific energies.

Lithium has a comparably very low density of 0.534 g/cm ³ and also a high standard reduction potential of −3.045 V for the half-reaction Li⁰→Li⁺+e⁻. This makes lithium an attractive candidate for making electrochemical cells with high energy density. However, secondary (rechargeable) electrochemical cells having a negative electrode of metallic lithium have shown to be encumbered with a persistent problem of dendrite formation upon charging which tends to short-circuit the electrochemical cell after a few charge-discharge cycles.

The dendrite problem was solved by applying a negative electrode capable of releasably storing lithium atoms by intercalation. Such batteries are known as secondary lithium-ion batteries (LIBs). The electrochemical properties of LIBs are directly influenced by the physical and chemical properties of the active material(s) of the negative electrode. Both material choice and preparation as well as appropriate architectural modification and design of the active material affects the battery performance. A key problem in this regard was, and still is, to find active materials which may reliably and reversibly store lithium atoms at a high volumetric density when the battery is charged and then release the lithium as ions (Li⁺) when being discharged in a high number of successive charge-discharging cycles.

At present, most of the commercially available LIBs apply graphite as the active material of the negative electrode. Graphite may host/pack one lithium-ion per six carbon atoms by intercalation with little shape deformation and has a theoretical specific energy of 372 mAh/g. Commercially available secondary LIBs with graphite anodes typically obtain a specific energy of 100-200 Wh/kg, making e.g. a mid-size long range electric car battery weigh several hundred kilos. This level of specific energy density is probably insufficient to realise the goal of the Paris Agreement.

### PRIOR ART

One strategy for improving the specific energy of LIBs is to find materials having higher storage capacity of lithium-ions than graphite for use as the active material of the negative electrode. One much investigated candidate in this regard is silicon, due to its high capacity for storing lithium atoms by diffusion and alloying. At typical ambient temperatures, the most lithiated phase of silicon is Li_{3.75}Si having a theoretic specific capacity of 3579 mAh/g, Qi et al. (2017) [1]. Negative electrodes of silicon also have the benefit of enabling providing an attractive working potential reducing the safety concerns related to lithium deposition upon cell over-charge Sourice et al. (2016) [2].

At is most lithiated state of Li_{3.75}Si , the silicon material has a volume of around 320% higher than its non-lithiated state. Wang et al. (2013) [4] have studied the diffusion kinetics of lithium in crystalline silicon and find that the diffusion rate og lithium in the silicon crystal is faster in the <110> direction than in the <100> and the <111> directions. This causes an anisotropic expansion of the silicon crystal upon lithiation and thus anisotropic stresses which may cause fracturing and pulverisation of the silicon material. This anisotropic stress has been found to be reduced in some anode configurations if the silicon material is amorphous as compared to crystalline silicon, Berla et al. (2014) [3], probably due to a more isotropic expansion of the amorphous silicon. The pulverisation of the silicon material results in rapid capacity fading of the battery due to loss of electric contact, loss of active material in the electrode, ineffective electron transfer, and repeated dynamic formations of solid electrolyte interfaces, etc. [1, 2].

It has been demonstrated that use of nanoscale particles in electrodes may provide electrodes with outstanding properties due to the small particle size causing effects such as improved electrical conductivity, improved mechanical and optical properties, etc. [1]. Furthermore, since nanosized particles have a very high surface area to volume ratio, negative electrodes having nanosized active materials may provide excellent charge/discharge capacity due to high available surface for absorption/desorption of lithium-ions [1].

There are several challenges in the silicon/graphite anode that are declining when the silicon particles are made smaller. The absolute expansion of each particle will be less, the mechanical pressure from each particle on their surroundings will be less and the diffusion distance for lithium inside silicon will be less. By increasing the surface-to-volume ratio, the current density over particle surfaces decreases, reducing harmful overpotentials.

On the other hand, the increasing surface area leads to new challenges such as some Li being locked in at the surfaces themselves (irreversible losses during the first cycles) in the anode as well as an increasing risk of auto-ignition in air and potentially larger irreversible first cycle losses related to silicon oxides formed during air exposure.

For LIBs having a liquid electrolyte, there will often be formed a solid electrolyte interface (SEI) during the first lithiation. The formation of the SEI-layer irreversibly consumes lithium and represents an irreversible capacity loss to the electro-chemical cell [1]. It is therefore advantageous to form a stable SEI-layer to limit the SEI-induced loss of lithium to the first lithiation/charging of the cell. It has been demonstrated that coating the silicon surface with a suitable element to avoid direct contact between the silicon and the electrolyte may provide a stable SEI-layer [1], but if cracks occur, unprotected surfaces will appear.

Carbon has been investigated and applied both as a coating material and/or as a composite material together with silicon in LIBs having nanostructured silicon as the active material in the negative electrode. Numerous silicon-carbon structures are reported in the literature, ranging from simple mixtures of silicon to complex geometries of silicon with graphene or graphite. These complex structures may exhibit excellent cyclability and capacity but are encumbered with requiring many charge-discharge cycles to reach high coulombic efficiencies and they require multi-step synthesis processes which are complicated to scale-up to commercial production levels [2].

From Sourice et al. (2016) [2] it is known a method for producing nanoscale amorphous silicon particles having a carbon shell/coating by a two-stage laser pyrolysis process where a gaseous flow of silane diluted in an inert gas enters a first reaction zone irradiated by a CO₂-laser to decompose the silane gas into amorphous silicon core particles. Then ethylene is added to the gas with the formed silicon core particles and the mixture is passed to a second reaction zone where it is irradiated by a CO₂-laser to decompose the ethylene into a carbon shell deposited onto the silicon core particles. The amorphous silicon particles with a carbon coating are found to have excellent specific capacity and high charge/discharge-cycling capability.

US 2012/0107693 discloses an active material for the negative electrode of a LIB including a silicon-containing compound of formula: SiCₓ, where x may be from 0.05 to 1.5, and where the carbon concentration in the material follows the relationship A≤B, where A is the mole concentration ratio of carbon relative to silicon at the centre of the active material and B is the mole concentration ratio of carbon relative to silicon on/at the surface area of the active material. The document informs that the carbon may be covalently bonded to the silicon and further that the silicon-containing compound may be particulate and have an amorphous molecular structure. It is further disclosed in paragraph of US 2012/0107693 that if the carbon content in the active material becomes too low, i.e. if x becomes less than 0.05, the active material may be deteriorated by cracking.

From EP 2 405 509 it is known an active material of a negative electrode for rechargeable LIBs including an amorphous silicon-based compound of formula: SiAₓH_{y}, where A is either carbon, nitrogen or a combination thereof, and where x>0, y>0, and 0.1≤x−y≤1.5. The active material may be particulate and coated by a carbon layer. The active material may be prepared by a sputtering process applying hydrogen gas and Si and C targets, or by a plasma method using hydrogen gas, silane gas and nitrogen gas.

WO 2018/052318 discloses a reactor and method for manufacturing crystalline or amorphous silicon particles by chemical vapour deposition of a silicon-containing precursor onto seed particles inside a heated and rapidly rotating reactor space. The silicon-containing gas may be diluted in a carrier gas and it may be one or a mixture of SiH₄, Si₂H₆, or SiHCl₃. The carrier gas may be one of hydrogen, nitrogen or argon. The formed silicon particles may be given an outer layer of a second material having lower silicon content than the core material of the particles by introducing a second precursor gas, liquid or material comprising C, O or N in combination with silicon, such as SiOₓ, SiCₓ, SiNₓ; amorphous carbon, graphite, low-crystalline carbon or low range order graphene structures.

Wang et al. (2013) [4] is one of several research groups that have disclosed the formation of a secondary particle from silicon nanoparticles and a carbon precursor such as pitch, and the use of such particles in a Li-ion battery. The secondary particle reduces the interface area between silicon and electrolyte, and thereby reduces formation of Solid Electrolyte Interphases (SEI), which are known to consume both lithium and electrolyte, thereby gradually reducing the capacity of the battery. The formation of (SEI) in the first cycles is quantified by measuring the Coulombic Efficiency (CE) of the first lithiation cycles, and the SEI thickness and quality can furthermore be estimated using XPS. It has been demonstrated by Jeff Dahn (1995) [5] that the CE of carbon formed from pitch or sugars is improved if the carbonization can occur at >500° C., preferably >700° C., more preferably >800° C. for at least two hours. Escamilla-Perez et al. (2019) [6] even pyrolyzed for 3 hours at 900° C.

EP 3 025 702 A1 discloses extremely pure, nanoparticulate, amorphous silicon powders, which optionally may be alloyed with electron donors and/or electron acceptors. Furthermore, a method for producing the silicon powder and the use of a reactor for producing the silicon powder are disclosed. The silicon powders according to the invention can preferably be used for the production of semiconductor starting materials, semiconductors, thermocouples for energy recovery from waste heat, in particular thermocouples which are stable at high temperatures.

KR 2016/0009807 discloses a silicon nanoparticle and a preparing method of the same. Particularly, this document relates to a silicon nanoparticle which comprises silicon as an active ingredient and has a non-crystalline or amorphous phase by having an excessive amount of atom P or atom B inside/outside the nanoparticle over a doping limit, and to a preparing method of the nanoparticle. The silicon nanoparticle produced can improve charging/discharging cycles (lifespan) of a secondary battery which uses the silicon nanoparticle as an anode material by having a second order phase of a non-crystalline or amorphous phase which acts as a shock absorber regarding volumetric expansion and contraction occurring during charging/discharging of silicon.

Thus, in summary, the optimal silicon-based negative active electrode material has several conflicting demands. It should comprise very small particles, to reduce cracking, but not so small as to give too high SEI formation or uncontrolled oxidation during production. It should have isotropic or close to isotropic expansion, meaning the powder should not be monocrystalline, but the production of the final anode material may require temperatures up to around 900° C. to improve coulombic efficiency, a temperature at which pure silicon nanoparticles will become crystalline. It should preferably be possible to charge fast also the first time of charging, and it should retain nearly all the high charging capacity of silicon with minimal first cycle efficiency losses.

### Objective of the Invention

The main objective of the invention is to provide nanoscaled silicon-containing particles suitable for use as the active material in negative electrodes in rechargeable lithium-ion electrochemical cells satisfying the requirements above, and method for manufacturing the nanoscaled silicon-containing particles.

A further objective of the invention is the provision of an anode material comprising the silicon-containing particles.

A further objective of the invention is the provision of a secondary electrochemical cell having a negative electrode comprising the nanoscaled silicon-containing particles.

### Description of the Invention

As given above, secondary lithium ion batteries (LIBs) with amorphous silicon particles as the active electrode material are found to have improved cycling capacity. This relates especially to nanoscale amorphous silicon particles having a carbon coating on their surface which, as reported by [2], are found to have excellent specific capacity and high charge/discharge-cycling capability.

The present inventors have discovered that preparing nanoscaled silicon particles by vapour condensation of a mixture of a silicon precursor gas and a relatively minor amount of a substitute element precursor gas produces silicon-containing particles having incorporated a few atom % of the substitution element in the silicon structure. The silicon phase is shown to be predominantly amorphous and to be more heat tolerant as compared to amorphous phases of pure silicon. That is, while amorphous pure silicon will begin to phase transform to crystalline silicon at temperatures of less than 700° C., the present predominantly amorphous particles with a few atom % guest elements in the silicon structure are observed to remain in the predominantly amorphous phase at temperatures up to around 750-820° C., depending on level of guest element substitution.

The increased temperature stability of these predominantly amorphous silicon-containing particles is beneficial in that it enables forming a carbon coating on the surface of the particles or a carbon based structure around them at a higher temperature without transforming the particles to the crystalline phase. I.e., the beneficial amorphous structure is maintained at higher coating temperatures, which as observed by [5], gives silicon particles with an improved coulombic efficiency as compared to particles coated or baked at lower carbonisation temperatures. Thus, an active electrode material containing such predominantly amorphous nanoscale silicon-containing particles enables forming secondary LIBs having relatively high cyclability, high specific capacity and high coulombic effect.

Another beneficial property of nanoscaled amorphous silicon is that the diffusion rate of lithium atoms in the silicon phase is higher as compared to crystalline silicon. This gives two advantages; there will be a more even distribution of lithium atoms (less congestion at the outer part) upon lithiation and thus a more even/-isotropic expansion of the silicon particle, and there will be a considerable time saving associated with the first lithiation of the negative electrode in industrial production of batteries.

The applicant has therefore applied for a patent protection of these predominantly amorphous silicon-containing particles in co-pending British patent application GB 2017168.2, incorporated herein in its entirety. The predominantly amorphous silicon-containing particles described in British patent application GB 2017168.2 are characterised by comprising a chemical compound of formula: Si₍₁₋ₓ₎Mₓ, where 0.005≤x<0.05 and M is at least one substitution element chosen from; C, N, or a combination thereof, and the particles, when subjected to XRD analysis applying unmonochromated CuKα radiation, exhibit one peak at around 28° and one peak at around 52°, and where both peaks have a Full Width at Half Maximum of at least 5° when using Gaussian peak fitting.

The British patent application GB 2017168.2 further discloses a negative electrode for a secondary lithium-ion electrochemical cell comprising at least one particulate active material being these predominantly amorphous silicon-containing particles, a particulate conductive filler material, a binder material, and a current collecting substrate, wherein the at least one particulate active material is embedded in the binder material to form an anode mass which is deposited as an anode mass layer onto the current collecting substrate.

The British patent application GB 2017168.2 also discloses composite particles comprising a plurality of the above defined predominantly amorphous particles and a predominantly carbon containing material made by pyrolysis of a carbon rich material. The British patent application GB 2017168.2 further discloses a method for manufacturing these predominantly amorphous silicon-containing particles, where the method comprises forming a homogeneous gas mixture of a first precursor gas of a silicon containing compound and at least one second precursor gas of a substitution element M containing compound, injecting the homogeneous gas mixture of the first and second precursor gases into a reactor space where the precursor gases are heated to a temperature in the range of from 700 to 900° C. so that the precursor gases react and form particles, and collecting and cooling the particles to a temperature in the range of from ambient temperature up to about 350° C., wherein the relative amounts of the first and the second precursor gases are adapted such that the formed particles obtain an atomic ratio M:Si in the range of [0.005, 0.05).

The term “predominantly amorphous” as used herein, encompasses silicon materials having a 100% amorphous molecular structure to silicon materials containing very small crystalline domains (practically undetectable by XRD-analysis) at the atomic length scale.

The present invention may be considered a further development of the invention described in British patent application GB 2017168.2, and is based on a further discovery that when heating these predominantly amorphous silicon-containing particles to temperatures at which they crystallises, e.g. a temperature of 800 to 900° C., they may attain significantly smaller crystallites as compared to the crystallite sizes obtained when amorphous particles of pure silicon are heated to the same temperature, depending on the content of carbon and/or nitrogen in the silicon structure.

As shown by Domi et al. (2019) [7], which has investigated the effect on the electrochemical properties of the crystallite sizes of equal sized silicon particles when applied as active electrode material in secondary LIBs, small crystallite sizes are favourable for such use by considerably improving the cyclability as compared to larger crystallite sizes. This effect is believed to be due to lithium ions diffuses faster along crystal boundaries than in bulk silicon (See for example Buonassisi et al. (2006) [8]) and that they diffuse faster the broader the boundary is. Domi et al. hypothesises that since grain boundaries between larger crystallites usually are broader than between smaller crystallites, the Li⁺ concentration gradient in the crystallite at the grain boundary becomes higher for larger crystallites as compared to smaller crystallites. This makes the strain from the corresponding volume expansion less for smaller crystallites making them more tolerant towards the volume changes associated with charge/discharge cycles. The reduced Li⁺ concentration gradient in the crystallites tends to negatively affect the rate performance since the Li-flux becomes smaller with smaller concentration gradients. On the other hand, this effect is counteracted by the surface area at which the Li atoms may enter the silicon becomes larger with smaller crystallites. Domi et al. (2019) [7] found a reduced rate performance when comparing particles with 80 nm crystallites with particles having 30 nm crystallites. This may not be the case with such small crystallites as 1 to 15 nm of the particles of the present invention since the surface area of the crystallites is considerably larger for such small crystallites.

A related, but not identical hypothesis is that the present inventors believe is likely to contribute is based on the same understanding that Li ions move faster along grain boundaries, but this then also implies that the expansion of a multi crystalline nano particle will be more isotropic and amorphous-like as compared to a mono-crystalline or few-crystalline nano particle. With fast ion transfer along grain boundaries, a multi crystalline nano particle will upon charging rapidly get Li ions distributed over several internal crystal boundaries. When the ions thereafter start diffusing into the bulk of each of the nanocrystals, which crystals will both be very small and have varying crystal orientations, the aggregate impact is that the particle itself will expand in a much more isotropic manner than a monocrystalline or a few- crystalline particle. This in turn will be very beneficial for the mechanical pressure on the surroundings of the nanoparticle. It will also reduce the tendency of the outer surface layer of the silicon particle to crack as compared to the monocrystalline situation where the outer layer is strongly expanded due to complete lithiation before the inner bulk phase starts expanding. In addition to this comes the fact that the Li ion in-diffusion will in practise have a much larger surface area to use since these internal surfaces rapidly exchange ions with the external surface. Therefore, the overpotential used to drive the exchange of ions across the particle surface can be reduced, and the risk of ionisation of silicon atoms on the surfaces are similarly reduced so that the surface can become more stable.

Furthermore, the relative abundance of crystallite boundaries in a multicrystalline silicon nanoparticle makes the process of first lithiation of the silicon particles being much faster as compared to a monocrystalline similarly sized silicon particle. This gives significant cost savings in a mass production line of secondary LIBs.

The thermodynamically stable condition at the temperatures at which the predominantly amorphous silicon-containing particles crystallizes is that the C and or N content of the particles are present as SiC and/or Si₃N₄ phases and the remaining Si is present as pure Si-crystals. That is, the C and/or N present in the Si₍₁₋ₓ₎Cₓ, or the Si₍₁₋ₓ₎Nₓ phase seek at these temperatures to diffuse out of the bulk phase and accumulate as either SiC or Si₃N₄ at the crystal boundaries. However, the reaction kinetics of the solid state diffusion is believed to be too slow to obtain a complete separation of Si and the C or N content during typical time spans of the heat treatments associated with manufacturing of negative electrodes for secondary LIBs. The resulting multicrystalline silicon-containing particle according to the invention is therefore expected to be somewhere between a pure Si₍₁₋ₓ₎Mₓ particle and a pure composite particle of Si, SiC and/or Si₃N₄. The total C and/or N content of the particle, however, will be the same regardless of degree of phase separation.

Furthermore, it has been observed that the formation of nanoscaled micro-crystallinity is favoured by somewhat higher guest element contents, as compared to the above given range for the predominantly amorphous particles.

Thus, in a first aspect, the invention relates to a silicon-containing particles, wherein
the particles have a surface area of from 25 to 182 m ²/g as determined by Brunauer-Emmet-Teller (BET) analysis according to ISO 9277:2010, characterised in that
the silicon-containing particles comprise a chemical compound of formula: Si₍₁₋ₓ₎Mₓ, where 0.005≤x≤0.20 and M is at least one substitution element chosen from; C, N, or a combination thereof Si₍₁₋ₓ₎Mₓ, where 0.005≤x≤0.20 , and
the chemical compound of the silicon-containing particles comprises crystallite sizes in the range of from 1-15 nm as determined by the Rietveld method.

The determination crystallite sizes by the Rietveld method is well-known to the person skilled in the art and belongs to the common general knowledge as evidenced by e.g. the textbook by R. A. Young ed., “The Rietveld Method” [9]. An example of practicing the Rietveld method applying XRD-data may be described as follows: The crystallite size, τ, is obtained from the widths of the sharp features, i.e. the Bragg peaks, in the XRD data. The analysis is performed by fitting the calculated XRD data from a model of crystalline Si to the experimental data with the least-squares method, a so-called Rietveld refinement [10]. The Rietveld refinement can be performed with freely available software such as GSAS-II [11] or commercial software such as Topas [12]. The instrumental contribution to the width of the Bragg peaks should either be calculated from the geometry of the instrument (“fundamental parameters approach”[13]) or be described by a Thomson-Cox-Hastings pseudo-Voigt function determined experimentally from a highly crystalline standard material such as NIST SRM 640f silicon. The instrumental contribution to Bragg peaks is kept fixed during the Rietveld refinement. All additional broadening of the observed Bragg peaks is assumed to be due to small crystallite size and to have Lorentzian shape. This crystallite size broadening is modelled by refining an additional contribution, β, to the calculated Bragg peak widths which varies with the scattering angle as:

$$β = \frac{λ}{τ * cos ( Θ )} \frac{360}{{π}^{2}}$$

where λ is the X-ray wavelength used in the XRD measurement. β is the additional full-width-at-half-maximum (FWHM) of a Bragg peak at scattering angle 2θ, i.e. the width in degrees halfway between the top and the bottom of the peak. The value of τ, the crystallite size, is allowed to vary freely during the Rietveld refinement and converge to the value that gives the best agreement between the experimental and calculated XRD data.

In an example embodiment, the silicon-containing particles according to the first aspect of the invention may advantageously only contain C and/or N (except for unavoidable impurities), i.e. the silicon-containing particles have a total content of C and/or N of from 0.05 to 20 atom %, the rest being Si and unavoidable impurities.

The chemical formula; Si₍₁₋ₓ₎Mₓ, where 0.005≤x≤0.20 as used herein is to be interpreted and understood according to Nomenclature of Inorganic Chemistry IUPAC Recommendations 2005, IR-11.3.2 “Phases with variable composition”. I.e., the formula defines a single (phase) chemical compound having a composition which may vary solely or partially by isovalent substitution of Si-atoms for M-atoms in an amount defined by the variable “x”. Thus, the term “silicon-containing particles” as used herein means that the particles are made of a silicon dominated phase containing an alloying element distributed in the molecule structure of the silicon phase. The M-atoms are chemically bonded and dispersed as in an alloy such that a plurality of the nearest and next nearest neighbour atoms of a typical M-atom is a Si-atom. Depending on material history, there may also be small inclusions of the separate phases SiC and Si₃N₄.

In an example embodiment, the silicon-containing particles according to the first aspect of the invention may comprise a chemical compound of formula: Si₍₁₋ₓ₎Mₓ, where M is at least one substitution element chosen from; C, N, or a combination thereof, and where 0.001≤x≤0.15, preferably 0.005≤x≤0.10, more preferably 0.0075≤x≤0.075, more preferably 0.01≤x≤0.05, and most preferably 0.02≤x≤0.03.

The particles according to the invention is found to have a density of approx. 2200 kg/m³. Thus, if it is assumed that these particles are spherical or quasi-spherical and non-porous, a BET surface area of from 25 to 182 m²/g corresponds to (approximate estimates) an average particle size in the range of from 15 to 110 nm.

Furthermore, in an example embodiment of the invention according to the first aspect, the silicon-containing particles may have a BET surface area of from 34 to 136 m²/g, preferably in the range of from 39 to 109 m²/g, more preferably in the range of from 45 to 91 m²/g, and most preferably in the range of from 54 to 68 m²/g. These BET surface areas correspond to an average particle size in the range of from 20 to 80 nm, preferably in the range of from 25 to 70 nm, preferably in the range of from 30 to 60 nm, and most preferably in the range of from 40 to 50 nm. The BET determination of the particle surface area is well known to the person skilled in the art. An example of a standard which may be applied to determine the BET surface area of the predominantly amorphous silicon-containing particles according to the first and second aspect of the invention is ISO 9277:2010.

Since the crystallite sizes are in the range of from 1-15 nm, which is smaller than the particle sizes of 15 to 100 nm, the silicon-containing particles according to the first aspect are multicrystalline nanoscaled particles. The multicrystalline structure, as observed by Domi et al. (2019) [7], make the particles according to the invention more resilient towards charge/discharge cycles than similarly nanoscaled silicon particles having larger and thus fewer crystallites. In an example embodiment of the invention according to the first aspect, the chemical compound of the silicon-containing particles may have crystallite sizes in the range of from 2 to 12 nm, preferably in the range of from 3 to 10 nm, more preferably in the range of from 4 to 8 nm, and most preferably in the range of from 5 to 6 nm, as determined by Rietveld refinements where the instrumental Bragg peak profiles were calculated from fundamental parameters and refined to account for Lorentzian and Gaussian sample broadening due to small particle size, and then the particle size was calculated with the Scherrer equation from the sample contribution to the full-width-at-half-maximum (FWHM) with a shape factor of 0.89.

In one example embodiment, the silicon-containing particles according to the first aspect of the invention may further comprise a carbon coating of a thickness of 0.2-10 nm, preferably in the range of from 1.5 to 8 nm, more preferably in the range of from 2 to 6 nm, and most preferably in the range of from 3 to 4 nm.

In one example embodiment, the silicon-containing particles according to the first aspect of the invention may further comprise a surface passivation made by reacting pristine silicon-containing particles with gaseous carbon monoxide, CO. I.e., the silicon-containing particles according to the first aspect of the invention may further comprise a coating covering at least a portion of a surface of the silicon particles, wherein the coating is a reaction product from reacting the silicon surface with gaseous carbon monoxide, CO.

As used herein, the term “reaction product from reacting the silicon surface with carbon monoxide” means that the surface coating is a result of simply contacting pristine silicon particles (particles with a non- or almost non-oxidised surface) with gaseous carbon monoxide at a partial pressure and temperature at which the CO reacts with the silicon surface of the particles and form a protective coating. The coating will in practice be a mixture of Si, O, and C atoms.

XPS investigations of the silicon particles indicate that the coating formed upon contact with CO is a mixture of reaction products where the gas has reacted both as functional groups and as dissociated atoms entering the molecular lattice of the silicon phase. The XPS analysis finds carbon atoms bounded to an oxygen atom indicating formation of a silicon carbonyl, SiₙCO, compound, and carbon atoms bounded to a silicon atom and oxygen atoms bonded to silicon atoms indicating that the CO molecule is dissociated and the carbon and oxygen atom are bound to separate Si atoms in the molecular lattice of the silicon phase. The XPS data also indicates that there may be formed four-membered ring structures of Si—O—Si—C on the particle surface.

The XPS results indicate that the molecular structure and composition of the coating derived from CO may be a complex mixture of reaction products from both dissociated and non-dissociated gas molecules making it difficult to define the coating as a chemical compound. However, the XPS analysis provides the atomic percent of the different elements present in the molecular lattice at the surface region where reflected radiation can escape to the detector. The X-rays will penetrate and retrieve information from a substantially equal depth into the molecular lattice of the silicon particles in each measurement such that the XRD analysis determines the atomic composition of a substantially equal thickness of the outermost bulk phase and the surface layer of the particles. The absorption cross section of radiation from different atoms may differ, leading to different signal based on the depth at which the different atoms is found. Some interpretation is therefore necessary and must be performed by a skilled operator with experience from similar materials. This makes the atomic composition determined by XPS an indirect measurement of the thickness of the coating derived from CO regardless of the particle size as long as the X rays and the reemitted signals do not penetrate through the entire particle and make the XPS analysis include the coating on the shaded side (backside) of the particles. In practice, this means that the XPS analysis is reliable as long as the silicon particles are 10 nm or more in diameter.

Transmission Electron Microscopy (TEM), and in particular Electron Energy Loss Spectroscopy (EELS) measurements can also be used to estimate the thickness, and in particular the homogeneity, of a coating layer. Because the TEM-image is a cross section of an entire particle, the coating can appear somewhat thicker than it really is, due to surface roughness or the curvature of the surface. Also, EELS may be less suitable than XPS for precise analysis of composition. TEM is therefore primarily used for verification of homogeneity, while XPS is used for qualitative and quantitative analysis of the surface coatings.

In an example embodiment, the thickness of the coating on the silicon-containing particles according to the first aspect of the invention may have a thickness in the range of from 0.1 to 3 nm, preferably of from 0.2 to 2 nm, more preferably of from 0.3 to 1.5 nm, more preferably of from 0.4 to 1.0 nm, more preferably of from 0.5 to 0.8 nm and most preferably of from 0.6 to 0.7 nm. The thickness can be determined by High Resolution Bright Field Transmission Electron Microscopy (TEM) to visualize the layer thickness. Scanning Transmission Electron Microscopy with Electron Energy Loss Spectroscopy and Energy Dispersive X-Ray Spectroscopy may be applied to confirm that both the particle and the observed outer layer has the expected chemical composition.

As used herein, the term “XPS analysis” refers to X-ray Photon Spectroscopy (XPS) measurements made in a spectrometer applying monochromated Al Kα radiation at 1486.6 eV, and the data analysis is made by using CasaXPS software with Shirley background subtraction and calibration of the energy axis using pure Si 2p 3/2=99.4 eV. It is possible to use spectrometers applying other radiation sources with other wave lengths and convert these measurements to be comparable to measurements applying monochromated Al Kα radiation at 1486.6 eV. Such conversations are well known to the skilled person.

The relatively high temperature tolerance of the silicon-containing particles according to the first aspect of the invention provides an advantage when applying the particles in the active material of a negative electrode of a secondary LIB. The silicon-containing particles are then typically mixed with graphite and binder and then pyrolyzed to embed the silicon-containing particles in a carbon matrix constituting the active material.

In a second aspect, the invention relates to a method for manufacturing the multicrystalline silicon-containing particles according to the first aspect of the invention, wherein the method comprises the following process steps:
forming a homogeneous gas mixture of a first precursor gas of a silicon containing compound and at least one second precursor gas of a substitution element M containing compound, where M is C or N, or a combination thereof,
injecting the homogeneous gas mixture of the first and second precursor gases into a reactor space where the precursor gases are heated to a temperature in the range of from 700 to 900° C. so that the precursor gases react and form predominantly amorphous silicon-containing particles,
subjecting the predominantly amorphous silicon-containing particles to a heat treatment in an inert atmosphere at a temperature in the range of from 800 to 900° C. for a time period of 0.1 to 4 hours to transform the amorphous silicon-containing particles to multicrystalline silicon-containing particles, and
cooling and collecting the multicrystalline silicon-containing particles, and wherein
the relative amounts of the first and the second precursor gases are adapted such that the formed particles obtain an atomic ratio M:Si in the range of [0.005, 0.25].

The term “first precursor gas of a silicon containing compound” as used herein means any silicon containing chemical compound being in the gaseous state and which reacts to form Si-particles at the intended reaction temperatures. Examples of suited first precursor gases include, but is not limited to, silane (SiH₄), disilane (Si₂H₆), and trichlorosilane (HCl₃Si), or a mixture thereof. Likewise, the term “second precursor gas of a substitution element, M, containing compound” as used herein means any chemical compound containing the substitution element M and which is in the gaseous state and participates in the gas reactions and causes M-atoms to be incorporated into the molecule structure of the Si-particles being formed when heated to the intended reaction temperatures. Examples of suited second precursor gases include, but is not limited to alkanes, alkenes, alkynes, aromatic compounds, or hydrides of N, hydrogen cyanide, and mixtures thereof.

Especially preferred example embodiments of precursor gas, i.e. the homogeneous gas mixture of a gaseous silicon and hydrogen compound and a gaseous substitution element M and hydrogen compound, are either silane (SiH₄) or disilane (Si₂H₆) mixed with a hydrocarbon gas chosen from one of; methane (CH₄), ethane (C₂H₆), propane (C₃H₈), ethene (C₂H₄), ethyne (C₂H₂), and mixtures thereof.

In an example embodiment of the method according to the second aspect of the invention, the homogeneous gas mixture of the first and second precursor gas is injected into the reactor space and heated to a temperature in the range of from 740 to 850° C., preferably in the range, optionally including a preheating of the homogeneous gas mixture of the first and second precursor gas to a temperature in the area of from 300 to 500° C. prior to insertion in the reactor space.

In an example embodiment of the method according to the second aspect of the invention, the relative amounts of the first and the second precursor gases are adapted such that the formed particles obtain an atomic ratio M:Si in the range of [0.0070, 0.177], preferably in the range of [0.0081, 0.11], preferably in the range of [0.0091, 0.081], and most preferably in the range of [0.01, 0.053].

In an example embodiment of the method according to the second aspect of the invention, the homogeneous gas mixture further comprises hydrogen, nitrogen, a noble gas like Helium, Neon, Argon, or any other gas that will not chemically react with the precursor gases at the temperatures specified.

In an example embodiment of the method according to the second aspect of the invention, the relative amounts of the first and the second precursor gases are adapted by regulating the flow rates of the first and second precursor gases being injected into the reactor and applying a mass spectrometer to measure the composition of the off-gas exiting the reactor to determine the fraction of the injected first and second precursor gas being converted to particles, and apply this information to deduce the atomic ratio M:Si in the formed particles and regulate the feed rates of the first and second precursor gases to obtain the intended atomic ratio M:Si in the particles being produced.

The notation for intervals as used herein follows the international standard ISO 80000-2, where the brackets “[” and “]” indicate a closed interval border, and the parenthesises “(“and ”)” indicate an open interval border. For example, [a, b] is the closed interval containing every real number from a included to b included: [a, b]={x∈ [symbol] |a≤x≤b}, while (a, b] is the left half-open interval from a excluded to b included: (a ,b]={x∈ [symbol] |a<x≤b}.

The homogeneous gas mixture may in example embodiments further comprise additional inert gases such as e.g. hydrogen, nitrogen, argon, neon, helium, and other gases which may be applied to affect heating, cooling, particle formation kinetics or mass transport, but will not leave chemical impurities in the final particle product. The heating of the precursor gases in the reaction chamber may be achieved by convection, conduction, radiation, laser, mixing with warmer gases or any other known method.

The reaction kinetics in the gas reactions forming the particles from the precursor gases may vary significantly depending on which gases are applied as the first and/or the second precursor gas, and the reaction temperature at which the particles are formed such that the atomic ratio M:Si in the precursor gases may deviate significantly from the atomic ratio M:Si in the produced particles. Thus, the term “the relative amounts of the first and the second precursor gases are adapted such that the formed particles obtain an atomic ratio M:Si in the range of” as used herein means that the relative amounts of the first and the second precursor gas being mixed and homogenised is adjusted such that the resulting particles obtain the intended atomic ratio when the precursor gas mixture is heated to the intended reaction temperature and reacts to form the particles.

The adaption of the relative amounts of the first and the second precursor gas to form the intended particles falls within the ordinary skills of the person skilled in the art. For example, the adaption of the relative amounts of the precursor gases for a given first and second precursor gas and intended reaction temperature may be obtained prior to a production stage by simply performing trial and error tests to determine the relative amounts to be applied with this gas mixture and reaction temperature.

Alternatively, the atomic ratio M:Si in the formed particles may be monitored/-determined by analysing the off-gas exiting the reactor in a mass spectrometer to determine how much of the supplied first and second precursor gases are being reacted/consumed inside the reactor and then determine in an indirect way the relative amounts of M and Si in the formed particles. For example by regulating the flow rates of the first and second precursor gases being injected into the reactor and applying a mass spectrometer to measure the composition of the off-gas exiting the reactor to determine the fraction of the injected first and second precursor gas being converted to particles, and apply this information to deduce the atomic ratio M:Si in the formed particles and regulate the feed rates of the first and second precursor gases to obtain the intended atomic ratio M:Si in the particles being produced.

The method according to the second aspect of the invention, may in one example embodiment, further comprise forming a surface passivating layer on the surface of the silicon-containing particles by the additional process steps of:
i) placing the silicon-containing particles in a reactor chamber,
ii) introducing a precursor gas containing carbon monoxide, CO, into the reactor chamber, and
iii) maintaining the silicon-containing particles in the reaction chamber for a period of time until the coating is formed on the silicon particles.

In a third aspect, the invention relates to a negative electrode of a secondary lithium-ion electrochemical cell, comprising:
at least one particulate active material,
binder material, and
a current collecting substrate, wherein the at least one particulate active material is embedded in the binder material to form an anode mass which is deposited as an anode mass layer onto the current collecting substrate, characterized in that
the or one of the at least one particulate active material is silicon-containing particles according to the first aspect of the invention.

In secondary electrochemical cells, the chemical half-cell reactions at the electrodes switch from oxidation to reduction reactions with the charge and discharge state of the charge/discharge cycle, respectively. As used herein, the term “negative electrode” is applied to denote the electrode of the electrochemical cell at which the oxidation side of the chemical reaction(s) takes place during discharge, i.e. the negative electrode is the electron producing electrode when drawing power out of the electrochemical cell. The negative electrode may also be denoted as the anode in the literature. The terms anode and negative electrode may be used interchangeably herein.

The negative electrode according to the third aspect of the invention may apply any conductive substrate known or conceivable to the skilled person being suited for use as the current collector in the negative electrode of secondary lithium-ion electrochemical cells. Examples of suited conductive substrates include but is not limited to; foils/sheets of graphite, aluminium or copper.

The negative electrode according to the third aspect of the invention may apply any binder material known or conceivable to the skilled person being suited for use a binder in the negative electrode of secondary lithium-ion electrochemical cells. Examples of suited binders include but is not limited to; styrene butadiene copolymer (SBR), carboxymethylcellulose (CMC), ethylene-propylene-diene methylene (EPDM), and polyacrylic acid (PAA).

In an example embodiment, the anode mass may further comprise a particulate conductive filler material mixed with and embedded together with the particulate active material in the binder material. The negative electrode according to the third aspect of the invention may apply any conductive filler material known or conceivable to the skilled person being suited for use a conductive filler of the anode mass for the negative electrode of secondary lithium-ion electrochemical cells. Examples of suited particulate conductive filler materials include but is not limited to; carbon allotropes such as graphene, reduced graphene oxide, an elastic polymer, a predominantly carbon containing material made by pyrolysis of a carbon rich material, carbon black, carbon nanotubes, or mixtures thereof.

In a fourth aspect of the invention, the crystallisation of the predominantly amorphous silicon particles forming the multicrystalline silicon-containing particles according to the first aspect of the invention may be obtained during a pyrolysis of a carbonaceous material containing a multiple of the predominantly amorphous silicon particles of the invention to form secondary particles. Each of said secondary particles may contain from ten up to maybe a million of the multi-crystalline silicon-containing particles of the invention as well as an amount of carbon formed by heat treatment of a precursor material comprising carbon atoms. This precursor material may for example be a large, carbon intensive molecule like oil or pitch. Alternatively, the precursor material could be a heavily cross-linked material such as resorcinol formaldehyde or melamine-formaldehyde where the pyrolysis can be used to form a predominantly carbon-containing nanoporous structure or a predominantly carbon-containing aerogel. The pyrolysis process can be performed at >600° C., preferably >700° C., or more preferably >800° C. In one example embodiment, the secondary particles may have a similar size as the graphite particles used in today's batteries, i.e. an average cross-section distance from for example 2 to 5 micrometres.

In a fifth aspect of the invention, the crystallisation of the predominantly amorphous silicon particles forming the multicrystalline silicon-containing particles according to the first aspect of the invention may be obtained during forming secondary particles having a graphene or graphene oxide as a conductive additive and as a protective barrier against the electrolyte. Said secondary particles can then again be used in the battery electrode and may comprise from e.g. ten up to maybe a million of the multicrystalline silicon-containing particles of the invention as well as an amount of graphene or reduced graphene oxide formed by heat treatment of a precursor material comprising oxidized graphene or graphene oxide. The reduction process can be performed at >600° C., preferably >700° C., or more preferably >800° C. In one example embodiment, the secondary particles may have a similar size as the graphite particles used in today's batteries, i.e. an average cross-section distance from for example 2 to 5 micrometres. The secondary particles may further include a binder or other component ensuring the geometrical stability of the secondary particles in later production steps.

In a sixth aspect of the invention, the multicrystalline silicon-containing particles according to the first and second aspect of the invention may be used to form secondary particles using an elastic binder as barrier against the electrolyte. The secondary particles could also comprise a conductive additive. Said secondary particles can then again be used in the battery electrode and may comprise from e.g. ten up to maybe a million of the predominantly amorphous silicon particles of the invention. The elastic binder could be any elastic polymer or plastic, including known elastomers such as imides, amides, silicones, styrene-butadiene-rubber, nitrile rubber. In one example embodiment, the secondary particles may have a similar size as the graphite particles used in today's batteries, i.e. an average cross-section distance from for example 2 to 5 micrometre.

In a seventh aspect of the invention, the crystallisation of the predominantly amorphous silicon particles forming the multicrystalline silicon-containing particles according to the first aspect of the invention may be obtained during forming secondary particles having a predominantly carbon containing material made by pyrolysis of a carbon rich material as a conductive additive and as a protective barrier against the electrolyte. Said secondary particles can then again be used in the battery electrode and may comprise from e.g. ten up to maybe a million of the multicrystalline silicon-containing particles of the invention as well as an amount of a predominantly carbon containing material made by pyrolysis of a carbon rich material. The pyrolysis process can be performed at >700° C., preferably >800° C. In one example embodiment, the secondary particles may have a similar size as the graphite particles used in today's batteries, i.e. an average cross-section distance from for example 2 to 5 micrometres. The secondary particles may further include a binder or other component ensuring the geometrical stability of the secondary particles in later production steps.

### LIST OF FIGURES

FIG. 1 is a diagram showing an XRD-analysis of silicon particles made at three different temperatures.

FIG. 2 is a diagram showing an XRD analysis of various samples of Si_{0.99}C_{0.01} and Si_{0.98}C_{0,02} made above 800° C. (samples R11_FA, R11_FB, and R11_FC) in nearly the same process as in FIG. 1 and still being fully amorphous.

FIG. 3 is a diagram showing an XRD analysis of Si_{0.92}C_{0.08} after heat treatment for two hours at 700° C. (R18-F2 700) and 800° C. (R18-F2 800), respectively. The curves show that Si_{0.92}C_{0.08} stays amorphous after 2 hours at 700° C. but starts to crystallize if it is exposed for 2 hours at 800° C.

FIG. 4 is a plot of crystallite sizes after two hours heat treatment at 800 or 900° C. as a function of carbon content of the silicon-containing particles.

### VERIFICATION OF THE INVENTION

The invention will be described in further detail by way of example embodiments.

### Comparison Example

Three samples of (pure) silicon particles were made by pre-heating a homogenous gas mixture of 33% silane diluted in hydrogen gas to about 400° C. and introducing the gas into a decomposition reactor and mixing the silane gas with preheated hydrogen gas having a temperature of 710° C., 745° C. and 770° C., respectively. The residence time in the reactor was approximate 1.5 seconds. The resulting silicon particles were rapidly cooled to below 300° C. and collected by filtration.

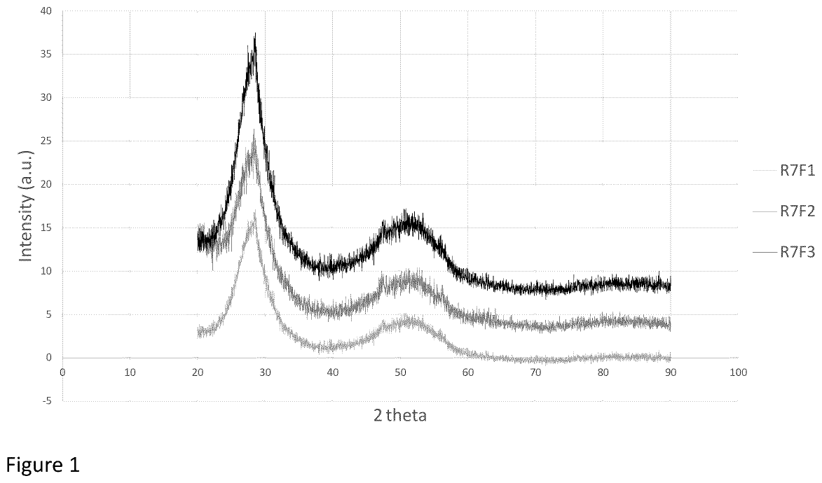

The sample particles were then analysed by XRD to investigate their atomic structure. The particles made at 710° C. (marked as RTF1 on FIG. 1) has a XRD-curve typical of amorphous silicon, the particles made at 745° C. (marked as RTF2 on FIG. 1) has a XRD-curve indicating some formation of crystalline silicon, while the particles made at 770° C. (marked as RTF3 on FIG. 1) has a XRD-curve typical of crystalline silicon.

### Preparation of Amorphous Precursor Particles

An example embodiment of the multicrystalline silicon particles according to the invention may be prepared as follows:

A homogeneous mixture of silane gas and ethene was preheated to about 400° C. and introduced into a reactor chamber. There the homogeneous mixture of silane gas and ethene was further mixed with an inert gas (nitrogen) which was preheated to a temperature giving a temperature in the resulting gas mixture of 810° C. The relative amounts of the gases in the final mixture were approximately 28 mole % silane, 1.5 mole % ethene and the rest (70 mole %) was nitrogen, which gave an atomic ratio of C:Si in the gas mixture of 0.05. The resulting particles, however, had an atomic ratio of C:Si of 0.02, i.e. the particles consisted of predominantly amorphous Si_{0.98}C_{0.02}.

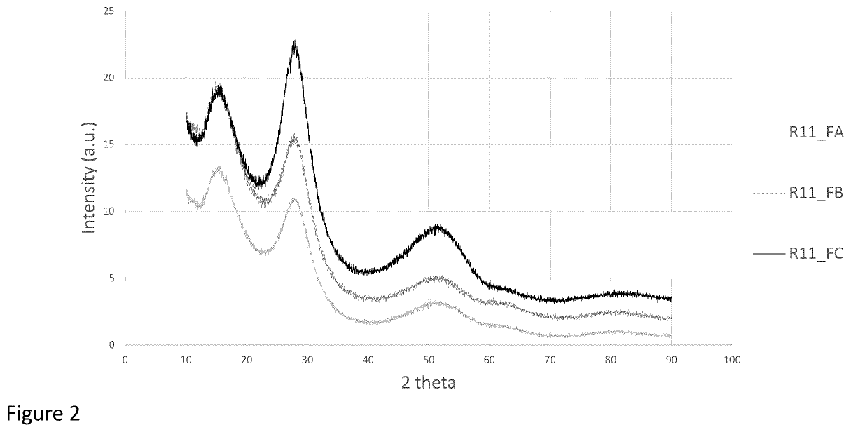

The residence time in the reactor was approximately 1.0 seconds. The exhaust gas and particles exiting the reactor space were thereafter rapidly cooled and collected in a filter. The particles were analysed by XRD to investigate their atomic structure. The result is shown in FIG. 2 as the curve marked with R11_FA. The XRD-curve is typical for silicon having an amorphous molecular structure.

Furthermore, three more embodiments of the predominantly amorphous particles were made in the similar way, except that the gas mixture comprised silane, ethene, ammonia and nitrogen. These samples where characterized using Differential Scanning Calorimetry to determine the crystallization temperature from the energy released during crystallization. The nitrogen content is not as easy to measure as the carbon content for these low inclusions, but based on linear extrapolation from samples with higher nitrogen content, and analysing the gas consumption in the reaction, is was estimated that the particles had compositions Siₓ,C_{y},N_{z} of: Si_{0.984}C_{0.016}N₀, Si_{0.992}, C₀₀₈,N₀, and Si_{0.976}C_{0.012}N_{0.012}.

All these samples showed an increased crystallization temperature as compared to the comparison particles of pure silicon described above, with the sample of estimated composition of Si_{0.976}C_{0.012}N_{0.012} having the highest crystallization temperature of 794° C. The two other samples showed a crystallinity temperature of being at least 10° C. lower, i.e. somewhat less than 784° C.

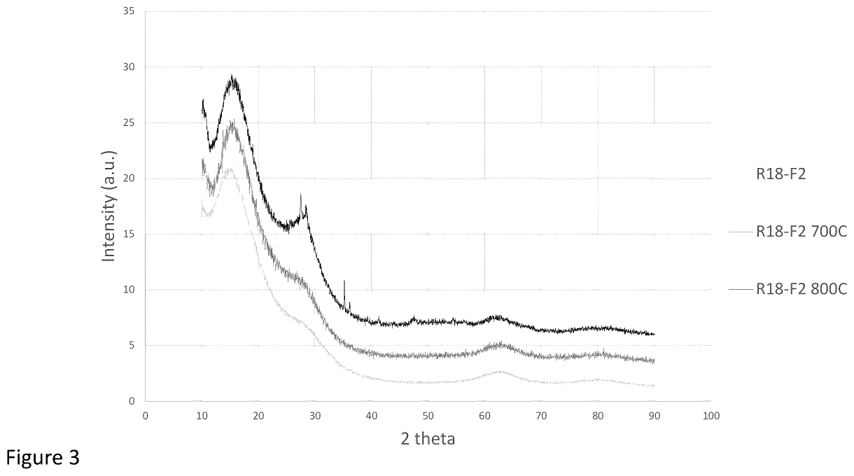

FIG. 3 shows an XRD analysis of the Si_{0.92}C_{0.08} sample after being subject to a heat treatment for two hours at 700° C. (marked R18-F2 700 on the figure) and 800° C. (marked R18-F2 800 on the figure), respectively. The curves show that Si_{0.92}C_{0.08} stays amorphous after 2 hours at 700° C. but starts to crystallize if it is exposed for 2 hours at 800° C.

### Verification of the Invention

A set of samples of predominantly amorphous particles were made in the same manner as shown in the above example. The particles had a BET of 34 m²/g (corresponding to a particle size of approx. 80 nm) having carbon contents as shown in table 1, i.e. ranging from zero C up to 3.1 weight % C. The particles were subject to a 2 hours heat treatment in an inert atmosphere at 700, 800 or 900° C.

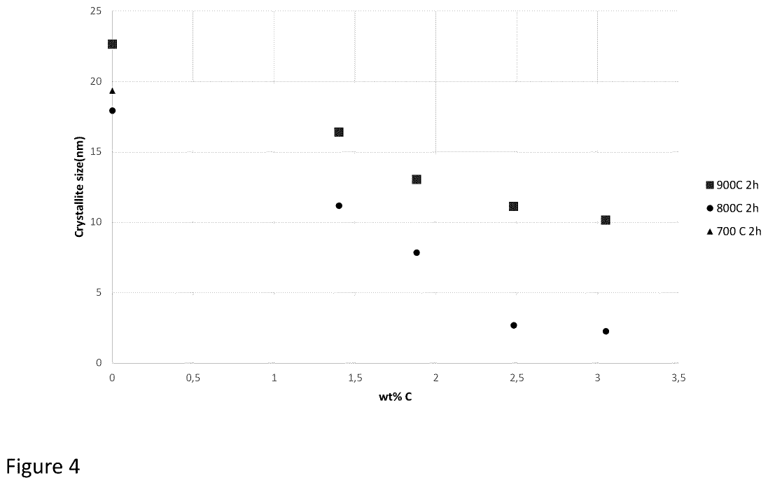

The crystallinity of the resulting particles were determined by Rietveld refinements with peak fitting assuming two phases with different grain size fractions. The crystallite sizes of the heat-treated particles were taken to be the linear average of the two different grain size fractions of each phase. The resulting crystallite sizes are plotted as a function of carbon content in FIG. 4. The carbon contents are given in weight % on the figure. 1.4 weight % C corresponds to 3.2 atom % C, which expressed as a chemical formula becomes: Si_{0.968}C_{0.032}.

As seen from Table 1 and FIG. 4, the predominantly amorphous pure silicon particles (no C) were transformed into a microcrystalline phase with relatively coarse crystallites of 18 to 22 nm, close to the particle size. However, the incorporation of relatively small amounts of carbon in the silicon molecular structure has the effect of forming significantly smaller crystallites upon heat treatment. Particles having a carbon content of 2.5 and 3.1 weight % (5.6 and 7.0 atom %, respectively) was found to have developed a microcrystalline structure with crystallite sizes of 1011 nm after two hours heat treatment at 900° C. and crystallite sizes of only 23 nm after two hours heat treatment at 800° C.

TABLE 1
Crystallite sizes of example embodiments of
Si₁₋ₓCₓ particles after 2 hours heat treatment

| | Phase 1 | | Phase 2 | | Avg. | | C |
|---|---|---|---|---|---|---|---|
| | Size | Fraction | Size | Fraction | size | Temp. | content |
| Sample | [nm] | [%] | [nm] | [%] | [nm] | [° C.] | [wt %] |
| H12-700 | 29.4 | 59 | 4.9 | 41 | 19.4 | 700 | 0.0 |
| H12-800 | 26 | 63 | 4.2 | 37 | 17.9 | 800 | 0.0 |
| H6F1-800 | 1.53 | 86.7 | 10.2 | 13.3 | 2.7 | 800 | 2.5 |
| H6F4-800 | 1.5 | 91.7 | 10.7 | 8.3 | 2.3 | 800 | 3.1 |
| H6F5-800 | 3.6 | 61 | 14.5 | 39 | 7.9 | 800 | 1.9 |
| H6F6-800 | 4.5 | 57.7 | 20.3 | 42.3 | 11.2 | 800 | 1.4 |
| H12-900 | 30.1 | 71 | 4.4 | 29 | 22.6 | 900 | 0.0 |
| H6F1-900 | 6.3 | 57 | 17.5 | 43 | 11.1 | 900 | 2.5 |
| H6F4-900 | 6.1 | 66 | 18 | 34 | 10.1 | 900 | 3.1 |
| H6F5-900 | 6.7 | 55 | 20.8 | 45 | 13.0 | 900 | 1.9 |
| H6F6-900 | 6.6 | 47 | 25.1 | 53 | 16.4 | 900 | 1.4 |

A similar test is also made with predominantly amorphous silicon-containing particles having either only N or N and C atoms in the molecular structure in amounts as give in table 2. The particles were subject to a two hour heat treatment in an inert atmosphere at 800 or 900° C. and the resulting crystallinity of the particles were determined by Rietveld refinements. As seen from table 2, predominantly amorphous silicon-containing particles having 1.4 weight % N (and no C) were also transformed to the microcrystalline phase having crystallites somewhat smaller than the crystallites obtained in pure silicon particles. When also some C was incorporated, the resulting crystallite sizes became comparable to the Si₁₋ₓCₓ particles given in table 1.

TABLE 2
Crystallite sizes of example embodiments of Si_{1-x-y}
N_{y}Cₓ particles after 2 hours heat treatment

| | Phase 1 | | Phase 2 | | Avg. | | C | N |
|---|---|---|---|---|---|---|---|---|
| | Size | Fraction | Size | Fraction | size | Temp. | content | content |
| Sample | [nm] | [%] | [nm] | [%] | [nm] | [° C.] | [wt %] | [wt %] |
| H8F1-800 | 3.9 | 69 | 14.5 | 31 | 7.2 | 800 | 2.1 | 0.8 |
| H8F2-800 | 4.9 | 58 | 18.1 | 42 | 10.4 | 800 | 0.9 | 1.1 |
| H8F4-800 | 3.5 | 64 | 13.9 | 36 | 7.2 | 800 | 1.5 | 1.5 |
| H8F5-800 | 6.3 | 43 | 23.8 | 57 | 16.3 | 900 | 0.0 | 1.4 |
| H8F1-800 | 6.2 | 61 | 19.3 | 39 | 11.3 | 900 | 2.1 | 0.8 |
| H8F2-800 | 6.6 | 41 | 23 | 59 | 16.3 | 900 | 0.9 | 1.1 |
| H8F4-800 | 5.6 | 56 | 17.4 | 44 | 10.8 | 900 | 1.5 | 1.5 |
| H8F5-800 | 7 | 33 | 25.7 | 67 | 19.5 | 900 | 0.0 | 1.4 |

### REFERENCES

1 Qi et al. (2017), “Nanostructured anode materials for lithium-ion batteries: principle, recent progress and future perspectives”, J. Mater. Chem. A, vol. 5, pp. 19521-19540
2 Sourice et al. (2016), “Core-shell amorphous silicon-carbon nanoparticles for high performance anodes in lithium-ion batteries”, Journal of Power Sources, vol. 328, pp. 527-535.
3 Berla, Lucas A.; Lee, Seok Woo; Ryu, Ill; Cui, Yi; Nix, William D. (2014), “Robustness of amorphous silicon during the initial lithiation/delithiation cycle”, Journal of Power Sources. 258: 253-259. Bibcode:2014JPS . . . 258 . . . 253B. doi:10.1016j.jpowsour.2014.02.032.
4 Wang Y. K., Chou S. L., Kim J. H., Liu H. K. and Dou S. X., “Nano-composites of silicon and carbon derived from coal tar pitch: Cheap anode materials for lithium-ion batteries with long cycle life and enhanced capacity” Electrochim. Acta, 2013, 93, 213-221.
5 Dahn, J. R., Zheng, T., Liu, Y., Xue, J. S., (1995), “Mechanisms for Lithium Insertion in Carbonaceous materials” Science, Vol. 270, Issue 5236, pp. 590-593.
6 Escamilla-Perez, A. M., Roland, A., Giraud, S., Guiraud, C., Virieux, H., Demoulin, K., Oudart, Y., Louvainac, N., and Monconduit, L., (2019), “Pitch-based carbon/nano-silicon composite, an efficient anode for Li-ion batteries”, RCS Advances, Vol. 9, pp. 10546-10553.
7 Domi, Y., Usui, H., and Sakaguchi, H., (2019) “Effect of Silicon Crystallite Size on Its Electrochemical Performance for Lithium-Ion Batteries”, Energy technol., Vol. 7, 1800946, DOI: 10.1002/ente.201800946.
8 Tonio Buonassisi, Andrei A Istratov, Matthew D Pickett, Matthias Heuer, Juris P Kalejs, Giso Hahn, Matthew A Marcus, Barry Lai, Zhonghou Cai, Steven M Heald T F Ciszek, R F Clark, D W Cunningharn, A M Gabor, R Jonczyk, S Narayanan, E Sauar, E R Weber (2006) “Chemical natures and distributions of metal impurities in multicrystalline silicon materials”, Progress in Photovoltaics: Research and Applications, page 513-531.
9 R. A. Young ed., “The Rietveld Method”, Oxford University Press, New York, 1993, ISBN 0-19-855577-6.
10 H. M. Rietveld, A Profile Refinement method for Nuclear and Magnetic Structures, Journal of Applied Crystallography, 2 (1969) 65-71.
11 B. H. Toby, R. B. Von Dreele, GSAS-II: the genesis of a modern open-source all purpose crystallography software package, Journal of Applied Crystallography, 46 (2013) 544-549.
12 A. A. Coelho, TOPAS and TOPAS-Academic: an optimization program integrating computer algebra and crystallographic objects written in C plus, Journal of Applied Crystallography, 51 (2018) 210-218.
13 R. W. Cheary, A. A. Coelho, J. P. Cline, Fundamental parameters line profile fitting in laboratory diffractometers, Journal of Research of the National Institute of Standards and Technology, 109 (2004) 1-25.
14 P. Thompson, E. D. Cox, J. B. Hastings, Rietveld Refinement of Debye-Scherrer Synchrotron X-ray Data from Al203, Journal of Applied Crystallography, 20 (1987) 79-83.

1. Silicon-containing particles, comprising:
a surface area of from 25.8 to 182 m²/g as determined by Brunauer-Emmet-Teller (BET) analysis according to ISO 9277:2010,
wherein
the silicon-containing particles comprise a chemical compound of formula: Si₍₁₋ₓ₎Mₓ, where 0.0005≤x≤0.20 and M is at least one substitution element chosen from; C, N, or a combination thereof, and
wherein the chemical compound of the silicon-containing particles comprises crystallite sizes in a range of from 1 to 15 nm as determined by a Rietveld method.

2. The silicon-containing particles according to claim 1, wherein the silicon-containing particles comprise a chemical compound of formula: Si₍₁₋ₓ₎Mₓ, where M is at least one substitution element chosen from C, N, or a combination thereof, and where 0.001≤x≤0.15, preferably 0.005≤x≤0.10, more preferably 0.0075≤x≤0.075, more preferably 0.01≤x≤0.05, and most preferably 0.02≤x≤0.03.

3. The silicon-containing particles according to claim 1, wherein the particles have a BET surface area of from 34 to 136 m²/g, preferably in a range of from 39 to 109 m²/g, more preferably in the range of from 45 to 91 m²/g, and most preferably in the range of from 54 to 68 m²/g, as determined by (BET) BET analysis according to ISO 9277:2010.

4. The silicon-containing particles according to claim 1, wherein the chemical compound of the silicon-containing particles have crystallite sizes in a range of from 2 to 12 nm, preferably in the range of from 3 to 10 nm, more preferably in the range of from 4 to 8 nm, and most preferably in the range of from 5 to 6 nm, as determined by Rietveld refinements where instrumental Bragg peak profiles were calculated from fundamental parameters and refined to account for Lorentzian and Gaussian sample broadening due to small particle size, and then the particle size was calculated with a Scherrer equation from a sample contribution to a full-width-at-half-maximum (FWHM) with a shape factor of 0.89.

5. The silicon-containing particles according to claim 1, wherein the particles further comprise a carbon coating of a thickness of 0.2 to 10 nm, preferably in a range of from 1.5 to 8 nm, more preferably in the range of from 2 to 6 nm, and most preferably in the range of from 3 to 4 nm.

6. The silicon-containing particles according to claim 1, wherein the particles comprise a coating covering at least a portion of its surface, and wherein the coating is a reaction product from reacting the surface of the silicon-containing particles with gaseous carbon monoxide, CO.

7. The silicon-containing particles according to claim 6, wherein the coating has a thickness in a range of from 0.1 to 3 nm, preferably in the range of from 0.2 to 2 nm, more preferably in the range of from 0.3 to 1.5 nm, more preferably in the range of from 0.4 to 1.0 nm, more preferably in the range of from 0.5 to 0.8 and most preferably in the range of from 0.6 to 0.7 nm, as determined by High Resolution Bright Field Transmission Electron Microscopy (TEM).

8. A method for manufacturing multicrystalline silicon-containing particles according to claim 1, the method comprising:
forming a homogeneous gas mixture of a first precursor gas of a silicon containing compound and at least one second precursor gas of a substitution element M containing compound, where M is C or N, or a combination thereof,
injecting the homogeneous gas mixture of the first and second precursor gases into a reactor space where the precursor gases are heated to a temperature in a range of from 700 to 900° C. so that the precursor gases react and form predominantly amorphous silicon-containing particles,
subjecting the predominantly amorphous silicon-containing particles to a heat treatment in an inert atmosphere at a temperature in the range of from 800 to 900° C. for a time period of 0.1 to 4 hours to transform the amorphous silicon-containing particles to multicrystalline silicon-containing particles, and
cooling and collecting the multicrystalline silicon-containing particles,
wherein relative amounts of the first and the second precursor gases are adapted such that the formed particles obtain an atomic ratio M:Si in a range of [0.005, 0.25].

9. The method according to claim 8, wherein the first precursor gas is silane (SiH₄), disilane (Si₂H₆), trichlorosilane (HCl₃Si), or a mixture thereof and the second precursor gas is chosen from methane (CH₄), ethane (C₂H₆), propane (C₃H₈), ethene (C₂H₄), ethyne (C₂H₂), alkanes, alkenes, alkynes, hydrides of N, hydrogen cyanide, or a mixture thereof.

10. The method according to claim 8, wherein the relative amounts of the first and the second precursor gases are adapted such that the formed particles obtain an atomic ratio M:Si in a range of [0.0070, 0.177], preferably in the range of [0.0081, 0.11], more preferably in the range of [0.0091, 0.081], and most preferably in the range of [0.01, 0.053].

11. The method according to claim 8, wherein the homogeneous gas mixture of the first and second precursor gases is preheated to a temperature in a range of from 300 to 500° C. prior to insertion in the reactor space, and then further heated after injection into the reactor space to a temperature in the range of from 740 to 850° C., preferably in the range of from 780 to 830° C., and most preferably in the range of from 790 to 820° C.

12. The method according to claim 8, wherein the homogeneous gas mixture further comprises hydrogen, nitrogen, a noble gas like Helium, Neon, Argon, or any other gas that will not chemically react with the precursor gases at the temperatures specified.

13. The method according to claim 8, wherein the relative amounts of the first and the second precursor gases are adapted by regulating flow rates of the first and second precursor gases being injected into the reactor and applying a mass spectrometer to measure a composition of an off-gas exiting the reactor to determine a fraction of the injected first and second precursor gas being converted to particles, and apply this information to deduce the atomic ratio M:Si in the formed particles and regulate feed rates of the first and second precursor gases to obtain an intended atomic ratio M:Si in the particles being produced.

14. The method according to claim 8, wherein the method further comprises coating the silicon-containing particles by:
placing the silicon-containing particles in a reactor chamber,
introducing a precursor gas containing carbon monoxide, CO, into the reactor chamber, and
maintaining the silicon-containing particles in a reaction chamber for a period of time until the coating is formed on the silicon particles.

15. A negative electrode of a secondary lithium-ion electrochemical cell, comprising:
at least one particulate active material,
binder material, and
a current collecting substrate,
wherein the at least one particulate active material is embedded in the binder material to form an anode mass which is deposited as an anode mass layer onto the current collecting substrate, and
wherein the or one of the at least one particulate active material is silicon-containing particles according to claim 1.

16. A negative electrode according to claim 15, wherein the current collecting substrate is a foil or a sheet of either graphite, Cu, or Al and the binder is either a styrene butadiene copolymer (SBR), carboxymethylcellulose (CMC), ethylene-propylene-diene methylene (EPDM), or polyacrylic acid (PAA).

17. A negative electrode according to claim 15, wherein the anode mass further comprises a particulate conductive additive material mixed with and embedded together with the particulate active material in the binder material.

18. A negative electrode according to claim 17, wherein the particulate conductive additive material is carbon black, carbon nanotubes, graphene, or a mixture thereof.

19. A composite particle for use in a negative electrode in a secondary lithium-ion electrochemical cell, wherein the composite particle comprises a plurality of the silicon-containing particle according to claim 1, and graphene or reduced graphene oxide.

20. A composite particle for use in a negative electrode in a secondary lithium-ion electrochemical cell, wherein the composite particle comprises a plurality of the silicon-containing particle according to claim 1, and a predominantly carbon-containing nanoporous structure or a predominantly carbon-containing aerogel.

21. A composite particle for use in a negative electrode in a secondary lithium-ion electrochemical cell, wherein the composite particle comprises a plurality of the silicon-containing particle according to claim 1, and a predominantly carbon containing material made by pyrolysis of a carbon rich material.

22. The silicon-containing particles according to claim 1, wherein the silicon-containing particles have a total content of C and N of from 0.05 to 20 atom %, the rest being Si and unavoidable impurities.
